(19) United States
(12) Patent Application Publication
(10) Pub. No.: US 2006/0136584 A1
(43) Pub. Date: Jun. 22, 2006

(54) System, network entity, client, method and computer program product for managing a contact list

(75) Inventors: Peter Decker, Marl (DE); Ricky Viray, Pacifica, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/016,496

(22) Filed: Dec. 17, 2004

(51) Int. Cl. G06F 15/173

(52) U.S. Cl. 709/224; 709/223; 709/206

(57) ABSTRACT

A system for managing a contact or buddy list includes a network entity, such as a game server, capable of providing a contact list identifying a plurality of members, where each identified member is associated with at least one criterion related to interaction of the member with the network entity. The network entity is also capable of dynamically creating at least one criteria-screened list based upon at least one of the criteria associated with the members listed in the contact list. More particularly, network entity is capable of dynamically creating the criteria-screened list based upon at least one of the criteria that is independent of a current presence of the client with respect to the network entity.

### FIELD OF THE INVENTION

The present invention generally relates to systems, methods and computer program products for operating an electronic multiplayer game, and more particularly, relates to systems, methods and computer program products for managing contact lists that include a plurality of clients interacting with an electronic multiplayer game.

### BACKGROUND OF THE INVENTION

Electronic games have become a widespread entertainment feature and are well known in the state of the art as video games or gaming machines. To increase the fun of the game many video games offer the option to play against a computer or against other persons. Some games can be played in a one, two or more player mode, to provide virtual adventures, or to economize expensive gaming equipment. There are actually many different gaming simulations such as sports games, car races, strategy games and even war games available. The attraction of some of these games resides in the fact that the games can be played via networks such as the Internet, enabling remote users to access and play different games with or against other real and/or virtual players, while being in different rooms, homes, towns, countries or even continents.

During play of electronic games, as in a number of other computing contexts, users desire to communicate with one another. Desktop computers, game consoles, workstations and other wireline computers that provide gaming applications currently allow users to communicate via e-mail, video conferencing, and instant messaging (IM) to name a few communication applications. Mobile devices, such as mobile telephones, handheld computers, personal digital assistants (PDAS) and the like, which are increasingly also providing gaming applications, also assist in day-to-day communication. Mobile/wireless telephones have conventionally served as voice communication devices, but through technological advancements have recently proved to be effective devices for communicating data, graphics, etc. Wireless and landline technologies continue to merge into a more unified communication system, as user demand for seamless communications across different platforms increases.

In many instances of providing communication applications such as instant messaging, a user maintains a contact list of other users with whom the user desires to communicate, such a list oftentimes referred to as a “friends list,” “buddy list” or the like. Thus, in one conventional context, an electronic game with instant messaging capabilities may provide users with a means for fast, interactive, mainly text-based communication with members of the user's buddy list. The utility of instant messaging may also be greatly enhanced by the addition of functionality that keeps track of the online status and availability of the members of the user's buddy list; and/or that may also notify the user of changes to their status or availability. Such functionality is oftentimes referred to as “presence functionality.” In the context of electronic gaming, the presence of a user or member of a user's buddy list can be considered based upon a number of different dynamic information related to the user or member connected to the electronic game via various means. Examples of information considered in determining the presence of a user include reachability, availability and location of the user or buddy list member for communication.

As will be appreciated, a user may have a buddy list that includes a large number of members, which may undesirably burden the user in reviewing the members of the buddy list, and selecting a member with whom the user desires to communicate during play of an electronic game. Applications that filter members of a buddy list based upon a current presence of those members within the electronic game may reduce the number of members presented to the user for selection, and thus, communication. Even in such instances, however, the number of members presented to the user may remain undesirably burdensome, particularly for mobile gaming devices that have limited display sizes. In such instances, the size of the buddy list can lead to a long delay in selecting the desired member, which can adversely affect play of the electronic game.

### SUMMARY OF THE INVENTION

In light of the foregoing background, embodiments of the present invention provide an improved system, network entity, client, method and computer program product for managing one or more contact or buddy lists. Embodiments of the present invention are capable of dynamically creating a criteria-screened buddy list based upon a buddy list associated with a client, and based upon one or more criterion (i.e., criterion/criteria) associated with the members of the buddy list associated with the client. In this regard, the criteria upon which the criteria-screened buddy lists are created can be related to the members of the buddy list and/or interaction of the members with a network entity, such as a game server during play of an electronic game, such as during online play of an electronic game. In contrast to conventional buddy lists, which may be sorted or otherwise filtered based upon a presence of the members with respect to a network entity, embodiments of the present invention are capable of dynamically creating criteria-screened contact lists based upon a number of criteria, at least one of which is independent of the presence of the members. By dynamically creating contact lists based upon such criteria, embodiments of the present invention may present a more focused list of members from which a particular client user may select to communicate therewith.

According to one aspect of the present invention, a system is provided for managing a contact or buddy list. The system includes a network entity, such as a game server, capable of providing a contact list identifying a plurality of members, where each identified member is associated with criteria, which may be related to the member, and/or interaction of the member with the network entity. In this regard, the network entity can be capable of collecting, generating and/or receiving the criteria, as well as updating the criteria, associated with the members of the contact list. In the context of an electronic game, for example, the criteria can relate to member information such as demographics, education level, membership in one or more groups, education level, gender, and the like. Additionally or alternatively, for example, the criteria can relate to gaming statistics such as a high score of one session, duration of at least one session, and/or an aggregate score associated with a plurality of sessions.

The network entity is also capable of dynamically creating at least one criteria-screened list based upon at least one of the criterion associated with one or more of the members listed in the contact list. Advantageously, network entity is capable of dynamically creating the criteria-screened list based upon at least one criterion independent of a current presence of the client/player/user device with respect to the network entity. As explained below, the network entity can be capable of collecting, generating and/or receiving the criteria before and/or after dynamically creating the criteria-screened list. Further, then, the network entity can be capable of dynamically creating a criteria-screened list before and after updating the criteria.

The system can further include a client capable of sending criteria to the network entity, where the criteria includes at least one criterion and at least one threshold value associated with the criterion/criteria. The network entity can then dynamically create the criteria-screened list by assembling the criteria-screened list based upon the criteria sent by the client, and received by the network entity. Upon dynamically creating the criteria-screened list, the client/user device can be capable of receiving the criteria-screened list from the network entity, and presenting the received list to a client user.

According to other aspects of the present invention, a method, network entity, client and computer program product are provided for managing a contact or buddy list. Embodiments of the present invention therefore provide an improved system, method, network entity, client, and computer program product for managing a contact list. Thus, embodiments of the present invention provide a framework for sorting contact lists, particularly those including a large number of other clients, to thereby tailor dynamically created contact lists to include only those members meeting criteria. As such, the system, game server, terminal and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from embodiments of the present invention;

FIG. 2 is a schematic block diagram of an entity capable of operating as a mobile station, game server, proxy server, personal computer (PC) system and/or game console, in accordance with embodiments of the present invention;

FIG. 3 is a schematic block diagram more particularly illustrating a mobile station in accordance with one embodiment of the present invention;

FIG. 4 is a schematic block diagram of an exemplar configuration of various network entities of the system of FIG. 1, in accordance with one embodiment of the present invention;

FIG. 5 is a functional block diagram of a client operating a communication application during play of an electronic game maintained by a network entity, in accordance with one embodiment of the present invention; and

FIG. 6 is a flowchart including various steps in a method of managing a contact list, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

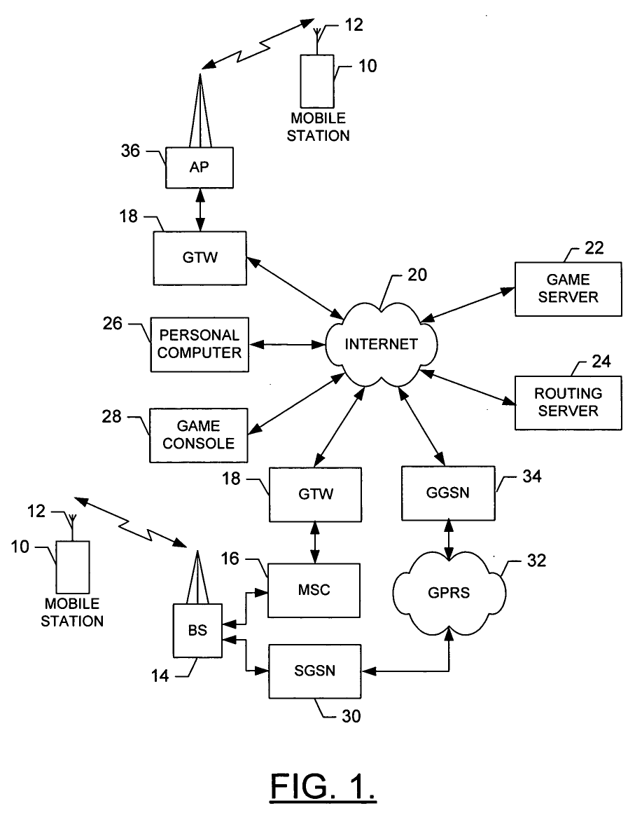

Referring to FIG. 1, an illustration of one type of system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

The system can include one or more mobile stations 10, each having an antenna 12 for transmitting signals to and for receiving signals from one or more base stations (BS's) 14, one of each being shown in FIG. 1. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the mobile station 10 via the Internet. For example, as explained below, the processing elements can include one or more processing elements associated with one or more game servers 22, routing servers 24, personal computer (PC) systems 26, game consoles 28, or the like, one of each being illustrated in FIG. 1 and described below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 14, the AP's can be directly coupled to the Internet. In one embodiment, however, the APs are indirectly coupled to the Internet via a GTW 18. As will be appreciated, by directly or indirectly connecting the mobile stations and the user processors (e.g., game servers 22, routing servers 24, personal computer (PC) systems 26, game consoles 28) and/or any of a number of other devices to the Internet, whether via the AP's or the mobile network(s), the mobile stations and user processors can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to game servers 22, routing servers 24, personal computer (PC) systems 26 and/or game consoles 28 across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques.

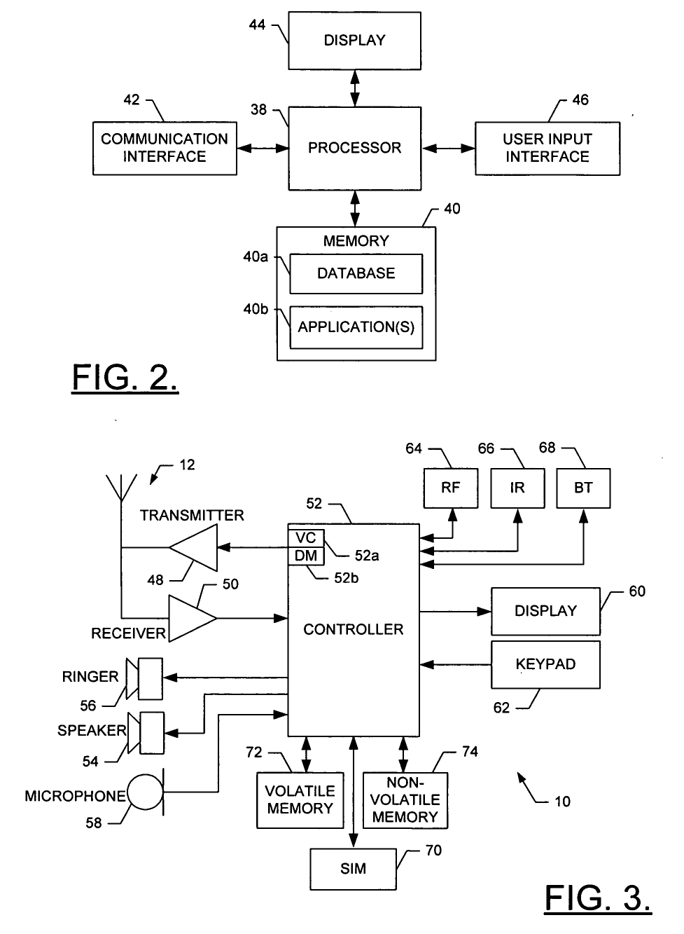

Referring now to FIG. 2, a block diagram of an entity capable of operating as a mobile station 10, game server 22, routing server 24, personal computer (PC) system 26 and/or game console 28, is shown in accordance with one embodiment of the present invention. Although shown as separate entities, in some embodiments, one or more entities may support one or more of a mobile station, game server, routing server, personal computer (PC) system and/or game console, logically separated but co-located within the entit(ies). For example, a single entity may support a logically separate, but co-located, game server and routing server. Also, for example, a single entity may support a logically separate, but co-located personal computer and game console.

As shown, the entity capable of operating as a mobile station 10, game server 22, routing server 24, personal computer (PC) system 26 and/or game console 28 generally includes a processor 38 connected to a memory 40. The memory can comprise volatile and/or non-volatile memory, and typically stores content, data or the like. For example, the memory typically stores content transmitted from, and/or received by, the entity. Also for example, when the entity comprises a game server or routing server, the memory can store a database 40a of clients capable of interacting with the respective entity, such as those clients registered to play an electronic game, where one or more clients in the database may be associated with one or more criterion related to the respective clients' interaction with the respective entity.

In addition, for example, the memory 40 of the entity capable of operating as a mobile station 10, game server 22, routing server 24, personal computer (PC) system 26 and/or game console 28 typically stores applications 40b, instructions or the like for the processor to perform steps associated with operation of the entity in accordance with embodiments of the present invention. For example, when the entity comprises a game server or routing server, the memory can store a client manager capable of managing clients (e.g., mobile station 10, personal computer (PC) system 26, game console 28, etc.) included in the database 40a, as well as the criteria associated with those clients. As also explained below, the memory of the entity capable of operating as a mobile station, game server, routing server, personal computer (PC) system and/or game console can store a contact list manager capable of managing one or more contact lists of one or more clients, such as one or more clients included in the database 40a. Further, when the entity comprises a mobile station, game personal computer (PC) system or game console, the memory can store a communication application, such as an instant messaging (IM) application, capable of effectuating communication functionality based upon contact lists received from the contact list manager. As described herein, applications such as the client manager, contact list manager and communication application each comprise software operated by the respective entities. It should be understood, however, that any one or more of the applications described herein can alternatively comprise firmware or hardware, without departing from the spirit and scope of the present invention.

In addition to the memory 40, the processor 38 can also be connected to at least one interface or other means for displaying, transmitting and/or receiving data, content or the like. In this regard, the interface(s) can include at least one communication interface 42 or other means for transmitting and/or receiving data, content or the like, as well as at least one user interface that can include a display 44 and/or a user input interface 46. The user input interface, in turn, can comprise any of a number of devices allowing the entity to receive data from a user, such as a keypad, a touch display, a joystick or other input device.

Reference is now made to FIG. 3, which illustrates one type of mobile station 10, a mobile telephone, which would benefit from embodiments of the present invention. It should be understood, however, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers, mobile gaming devices and other types of electronic systems, can readily employ the present invention.

As shown, in addition to an antenna 14, the mobile station 10 can include a transmitter 48, receiver 50, and controller 52 or other processor that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, EDGE, or the like. Further, for example, the mobile station may be capable of operating in accordance with 3G wireless communication protocols such as UMTS network employing WCDMA radio access technology. Some NAMPS, as well as TACS, mobile stations may also benefit from the teaching of this invention, as should dual or higher mode phones (e.g., digital/analog or TDMA/CDMA/analog phones).

It is understood that the controller 52 includes the circuitry required for implementing the audio and logic functions of the mobile station 10. For example, the controller may be comprised of a digital signal processor device, a microprocessor device, and various analog-to-digital converters, digital-to-analog converters, and other support circuits. The control and signal processing functions of the mobile station are allocated between these devices according to their respective capabilities. The controller can additionally include an internal voice coder (VC) 52a, and may include an internal data modem (DM) 52b. Further, the controller may include the functionality to operate one or more client software programs such as those indicated above, which may be stored in memory (described below).

The mobile station 10 also comprises a user interface including a conventional earphone or speaker 54, a ringer 56, a microphone 58, a display 60, and a user input interface, all of which are coupled to the controller 52. Although not shown, the mobile station can include a battery for powering the various circuits that are required to operate the mobile station, as well as optionally providing mechanical vibration as a detectable output. The user input interface, which allows the mobile station to receive data, can comprise any of a number of devices allowing the mobile station to receive data, such as a keypad 52, a touch display (not shown), a joystick (not shown) or other input device. In embodiments including a keypad, the keypad includes the conventional numeric (0-9) and related keys (#, *), and other keys used for operating the mobile station.

The mobile station 10 can also include one or more means for sharing and/or obtaining data. For example, the mobile station can include a short-range radio frequency (RF) transceiver or interrogator 64 so that data can be shared with and/or obtained from electronic devices in accordance with RF techniques. The mobile station can additionally, or alternatively, include other short-range transceivers, such as, for example an infrared (IR) transceiver 66, and/or a Bluetooth (BT) transceiver 68 operating using Bluetooth brand wireless technology developed by the Bluetooth Special Interest Group. The mobile station can therefore additionally or alternatively be capable of transmitting data to and/or receiving data from electronic devices in accordance with such techniques. Although not shown, the mobile station can additionally or alternatively be capable of transmitting and/or receiving data from electronic devices according to a number of different wireless networking techniques, including WLAN techniques such as IEEE 802.11 techniques or the like.

The mobile station 10 can further include memory, such as a subscriber identity module (SIM) 70, a removable user identity module (R-UIM) or the like, which typically stores information elements related to a mobile subscriber. In addition to the SIM, the mobile station can include other removable and/or fixed memory. In this regard, the mobile station can include volatile memory 72, such as volatile Random Access Memory (RAM) including a cache area for the temporary storage of data. The mobile station can also include other non-volatile memory 74, which can be embedded and/or may be removable. The non-volatile memory can additionally or alternatively comprise an EEPROM, flash memory or the like. The memories can store any of a number of software applications, instructions, pieces of information, and data, used by the mobile station to implement the functions of the mobile station.

As will be appreciated, a number of the entities of the system of FIG. 1 can be configured in any of a number of different architectures to perform any of a number of functions. For example, the entities of the system of FIG. 1 can be configured in a centralized client-server architecture, decentralized architecture and/or proxy architecture. Additionally or alternatively, for example, the entities of the system of FIG. 1 can be configured in an architecture given in the Scalable Network Application Package (SNAP) (formerly Sega Network Application Package) provided by Nokia Corporation for applications such as in the context of electronic gaming.

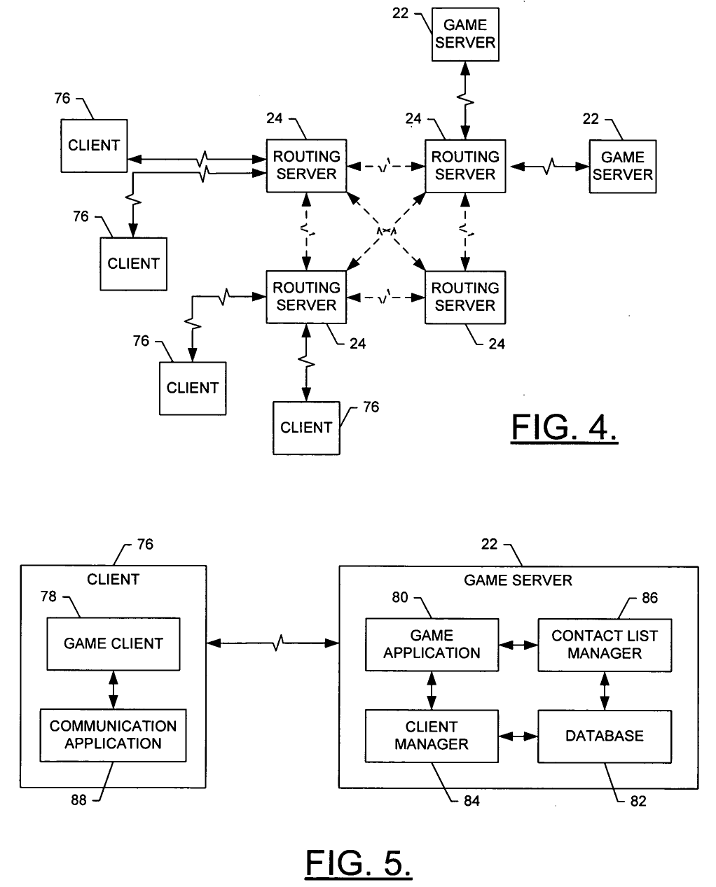

More particularly, as shown in FIG. 4, for example, one or more mobile stations 10, PC systems 26 and/or game consoles 28 may operate as clients 76 in an electronic gaming architecture that also includes one or more game servers 22 and/or routing servers 24. In the illustrated architecture, similar to a conventional client-server architecture, the game servers operate electronic games and maintain the state of those games. As will be appreciated, however, the routing servers and/or one or more of the clients themselves may alternatively operate portions, or all, of the electronic games and maintain the state of those games. As used herein, then, although electronic games can be operated by one or more network entities, including game servers, routing servers and/or client(s), the following description may refer to a game server as operating the electronic games for purposes of illustration. Irrespective of the network entit(ies) that operate the electronic games, however, the clients operate game applications that communicate with those network entit(ies) to continuously change the game state of the games operated and maintained by the network entit(ies) to thereby play those games.

Also in the illustrated architecture, the clients 76 are coupled to routing servers 24 which, in turn, are coupled to the game servers 22. Thus, the routing servers route data packets between one or more clients 76 and the game servers 22, and/or other clients, to facilitate the operation of each entity in the architecture. As shown, the routing servers can be coupled between groups of clients and one or more game servers, directly or indirectly via one or more other routing servers. In this regard, one or more routing servers can also be coupled to other routing servers such that the routing servers can also be coupled between one or more clients and one or more groups of other clients, such as groups of clients coupled to other routing servers.

As explained above in the background section, in the context of an electronic game with communication (e.g., instant messaging) capabilities, clients 76 may be provided with a means for fast, interactive, mainly text-based communication with members (i.e., one or more other clients) of a contact list (i.e., buddy list) associated with the respective clients, or more particularly associated with users of the respective clients. However, various clients may be associated with buddy lists that include a large number of members, which may undesirably burden the client user in reviewing the members of the buddy list, and selecting a member with whom the user desires to communicate during play of an electronic game. Applications that filter members of a buddy list based upon a current presence of those members within the electronic game may reduce the number of members presented to the user for selection, but even in such instances, the number of members presented to the user may remain undesirably burdensome, particularly for mobile gaming devices that have limited display sizes.

Embodiments of the present invention therefore provide a framework for overcoming the drawback of conventional buddy lists in that a client 76 is capable of receiving dynamically created contact lists based upon one or more criterion, such as criteria associated with one or more members of the contact list and/or interaction of the respective members with the game server, or more particularly the online game operated and maintained by the game server. By dynamically creating contact lists based upon such criteria, embodiments of the present invention may present a more focused list of members from which a particular client user may select to communicate therewith. In this regard, embodiments of the present invention provide a framework for criteria-screening contact lists, particularly those including a large number of other clients, to thereby tailor dynamically created contact lists to include only those other clients associated with criteria desired by the particular client, or particular client user. In operating and maintaining the state of an electronic game, the game server is capable of collecting, generating or otherwise receiving information related to client users, such as demographics, education level, membership in one or more groups, education level, gender, and the like, that could additionally or alternatively be used to screen contact lists of respective clients. In addition, the game server can be capable of collecting, generating or otherwise receiving a wealth of statistical information that is currently unused that could be used to screen contact lists of respective clients, or possibly even one or more default contact lists not otherwise associated with any particular client (e.g., universal contact list of all clients registered to play an electronic game).

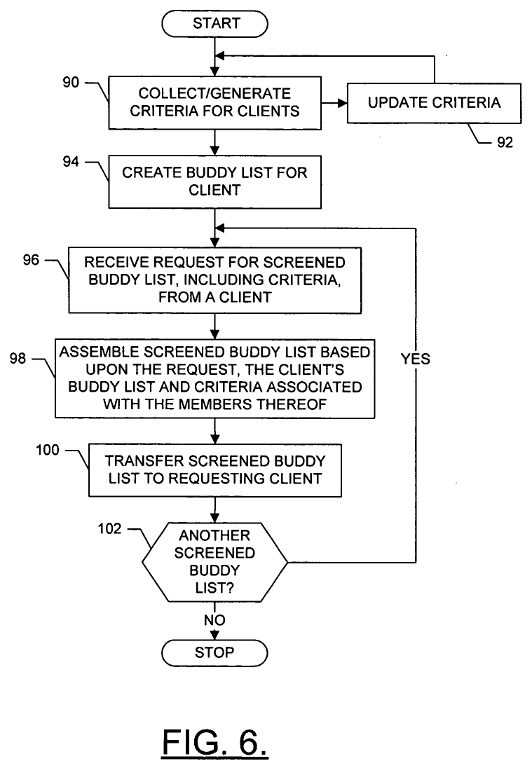

Reference is now drawn to FIGS. 5 and 6, which illustrate functional block diagram and method, respectively, for managing a contact list (i.e., buddy list) in an electronic game. As shown in FIG. 5, a client 76 communicates with a game server 22 to play a multiplayer electronic game. In this regard, the client is capable of operating a game client 78 to effectuate game play locally at the client, while the game server is capable of operating a game application 80 for operating the electronic game and maintaining the state of that electronic game based at least in part on communication with the client, and may also be based at least in part on communication with a number of other clients.

In accordance with embodiments of the present invention, the game server 22 is capable of maintaining a database 82 (i.e., database 40a) of clients capable of interacting with the respective entity, such as those clients 76 registered to interact with the game application 80 to play the electronic game, as indicated above with reference to FIG. 2. The database can further include, associated with a number of clients, criteria related to the respective clients or client users, and/or clients' or client users' play of the electronic game. For example, the database can include criteria related to member information such as the client users' demographics, education level, membership in one or more groups, education level, gender, and the like. Additionally or alternatively, the database can include criteria related to gaming statistics such as the duration of one or more gaming sessions (i.e., periods of time when the client interacts with the electronic game to effectuate game play), the score (e.g., high score) achieved by the client user for one or more gaming sessions, an aggregate score achieved by the client user for a plurality of gaming sessions, or the like. The game server can also operate a client manager 84 capable of managing clients included in the database, including collecting, generating or otherwise receiving one or more criterion related to the clients and/or interaction of the clients with the game server, and associating those criteria with the respective clients in the database.

Further, the game server 22 can operate a contact list manager 86 capable of managing one or more contact lists of one or more clients 76, such as those clients included in the database 82, where the contact lists may be stored by the game server operating the contact list manager or by the respective clients. The contact list of each client may include or otherwise identify one or more other clients, where the contact lists may be referred to as a “buddy list” and the clients included therein may be referred to as “members” of that buddy list. In this regard, as explained below, the contact list manager can be capable of managing a contact list of a client by receiving, from the client, one or more criterion and one or more threshold values associated with those criteria, and communicating with the database 82 to dynamically create a criteria-screened buddy list based upon the criteria and the client's buddy list. The contact list manager can then provide or otherwise transfer the criteria-screened buddy list to the client. The client, or more particularly a communication application 88 (e.g., IM application) operated by the client, can then receive the criteria-screened buddy list and present the criteria-screened buddy list to the client user such that the client user can select a member of the criteria-screened buddy list with whom to communicate, such as in accordance with a conventional IM technique.

As shown and described herein, the game application 80, client manager 84 and contact list manager 86 comprise separate applications operated by the game server 22, or more generally the network entity operating and maintaining the state of an electronic game. It should be understood, however, that one or more applications may support one or more of the game application, client manager and/or contact list manager, logically separated but co-located within the application(s). For example, an application may support both the client manager and contact list manager; or support all of the game application, client manager and contact list manager. At the client 76, one or applications may similarly support both of the game client 78 and the communication application 88, logically separated but co-located within the same application.

Further, as shown and described herein, the contact list manager 86 is operated by the game server 22, where the contact list manager manages the contact lists of a number of clients 76. It should be understood, however, that one or more clients may alternatively be capable of operating a contact list manager to thereby manage the contact list of the respective client(s). Thus, the game server and/or one or more clients may be capable of operating a contact list manager. For example, when the game server and one or more clients operate a contact list manager, the contact list manager(s) operated by the client(s) can manage the contact list(s) of the respective client(s), while the game server manages the contact lists of other clients.

Now with reference to FIG. 6, a method of managing for managing a contact list (i.e., buddy list) in an electronic game includes providing a plurality of clients 76 capable of interacting with a game server 22, or more particularly a game application 80 operated by a game server, to thereby play an electronic game. For example, a plurality of clients, or client users, may register with the game server to play an electronic game operated and maintained by the game server, such as by means of game clients 78 operated by the respective clients. In this regard, the client manager 84 may facilitate registering the client users with the game server, and thereafter maintain a database 82 of those registered client users. Then, to play the electronic game operated and maintained by the game server, the registered client users may operate the game client to log in or otherwise authenticate to the game server, and thereafter interact with the game application to play the electronic game.

As the clients 76, or more particularly the game clients 78 operated by the clients, interact with the game server 22, the client manager 84 collects, generates or otherwise receives one or more criterion related to the respective clients or client users, and/or interaction of the respective clients or client users with the game server, as shown in block 90. For example, the client manager can collect, generate or otherwise receive criteria relating to member (client) information such as demographics, education level, membership in one or more groups, education level, gender, and the like. Additionally or alternatively, for example, the criteria can comprise gaming statistics related to the respective clients' or client users' play of the electronic game. Such gaming statistics can include, for example, the duration of one or more gaming sessions, the score achieved by the client user for one or more gaming sessions, an aggregate score achieved by the client user for a plurality of gaming sessions, or the like. Then, as the client manager collects, generates or otherwise receives the criteria, the client manager can associate those criteria with the respective clients in the database 82 managed by the client manager. And as will be appreciated, as the clients or client users interact with the game server one or more criterion related to the clients and/or interaction of the clients with the game server may change. Thus, the client manager may continuously, repeatedly, or otherwise at one or more instances in time update the criteria, such as during or at the conclusion of gaming sessions of the respective client or client users, as shown in block 92.

Also in accordance with the method of embodiments of the present invention, one or more clients 76 or client users may create a contact or buddy list of other clients capable of interacting with the game server 22, as shown in block 94. In this regard, a client may create a buddy list at any of a number of different instances, and in any of a number of different manners. For example, at any time after registering with the game server 22 to play the electronic game operated and maintained by the game server, a client or client user may create a buddy list including or otherwise identifying one or more other clients or client users registered with the game server. The client user can then select the members of the buddy list by manually entering, into the game client 78 or communication application 88 operated by the client, the usernames or other identifiers of other client users registered with the game server, for example. Additionally or alternatively, for example, the client user can select the members of the buddy list by selecting one or more usernames or other identifiers of other clients from a list of a plurality of clients registered with the game server, which the client manager 84 can provide from the database 82.

As will be appreciated, in one or more instances, a client user may desire a criteria-screened buddy list but not otherwise have created a buddy list. In such instances, the respective client or client user may be otherwise associated with a “default” buddy list that includes a number of members. The members of the default buddy list can be selected in any of a number of different manners. For example, the members of the default buddy list can include all of the clients capable of interacting with the game server (e.g., those clients registered to play the electronic game operated and maintained by the game server). Alternatively, for example, the members of the default buddy list can include all of the clients currently present with respect to the game server, as such may be determined based upon presence information associated with the clients. Such presence information may include, for example, the reachability, availability and location of the client or client user for communication, one or more of which may be determined based upon a current interaction of the client or client user with respect to the game server.

Irrespective of how the client 76 or client user creates a buddy list, the members of the buddy list (i.e., other clients) are associated with criteria collected, generated or otherwise received, and updated, by the client manager 84. Thus, at one or more instances after creating the buddy list, the client or client user may screen or otherwise filter the members of the client's buddy list based upon one or more of the criterion associated with the members of the client's buddy list. As shown in block 96, then, a client 76, or more particularly a communication application 88 operated by a client, can send, and the contact list manager 86 can receive, a request for a criteria-screened buddy list, where the request includes one or more criterion, and may also specify one or more threshold values, from which to dynamically create the criteria-screened buddy list. In this regard, after creating the buddy list, the communication application may solicit, from the client user, one or more criterion, and if so desired one or more threshold values, from which to dynamically create a criteria-screened buddy list. For example, criteria may specify members of the buddy list having a score above a threshold score, and/or members of the buddy list having one or more gaming session durations at or above a threshold length of time.

In addition to soliciting criteria and threshold values, if so desired, the communication application 88 may facilitate creation of the criteria-screened buddy list by presenting the client's buddy list to the client user, where the client's buddy list is retrieved from local memory or received from the contact list manager if maintained thereby. Further, in presenting the client's buddy list, the communication application may also communicate with the game server to indicate, or filter the buddy list to only present, those members of the buddy list currently interacting with the game server based upon presence information generated by or otherwise provided to the game server. Having received the criteria from the client or client user, then, the communication application can transfer the criteria to the contact list manager.

After receiving the request, the contact list manager 86 can assemble a criteria-screened buddy list based upon the criteria sent by the client 76 and received by the client list manager, the client's buddy list and the criteria associated with the members of the client's buddy list, as shown in block 98. More particularly, the contact list manager can communicate with the client manager 84 or directly with the database 82 to identify, from the clients included in the database 82, the members of the client's buddy list that are associated with criteria matching that specified in the request from the client, or more particularly the communication application 88. In this regard, the client's buddy list can be retrieved from the request from the client, or locally if the buddy list is maintained by the client list manager. Then, from the members associated with the specified criteria, the contact list manager can identify those members associated with criteria meeting the threshold(s) specified in the request. Thereafter, the contact list manager assembles, into a criteria-screened buddy list, those members of the client's buddy list that are associated with requested criteria that meet the specified thresholds. Thus, as will be appreciated, the criteria-screened buddy list includes the subset of the members of the client's buddy list that meet the criteria included in the client's request for a criteria-screened buddy list. In other terms, the criteria-screened buddy list comprises the client's buddy list filtered to exclude those members not meeting the criteria included in the client's request.

After creating the criteria-screened buddy list, the contact list manager 86 can provide or otherwise transfer the criteria-screened buddy list to the requesting client 76, or more particularly the communication application 88 of the requesting client, as shown in block 100. The communication application can then utilize the criteria-screened buddy list in any of a number of different manners, including any of a number of conventional manners. For example, the communication application can present the criteria-screened buddy list to the client user such that the client user can select a member of the criteria-screened buddy list with whom the client user desires to communicate. By selecting a member, then, the client user may direct the communication application to initiate communication with the respective member such that the client user and selected client user may thereafter exchange messages, such as during play of the electronic game operated and maintained by the game server 22.

At one or more instances the client 76 may request other criteria-screened buddy lists based upon the same or different criteria, as shown in block 102. For each request for a criteria-screened buddy list, then, the contact list manager 86 can receive a request from the client, create the criteria-screened buddy list and provide the criteria-screened buddy list to the client. As will be appreciated, changing the criteria from one request to another may change the resulting criteria-screened contact list created by the contact list manager. Similarly, updating the criteria associated with the members of the client's contact list may also change the resulting criteria-screened contact list created by the contact list manager. Thus, the criteria-screened contact list may be considered to be dynamically created by the contact list manager in that the criteria-screened contact list created by the contact list manager at one instance may differ from the criteria-screened contact list created by the contact list manager at any other instance, even if the criteria-screened contact lists are created based upon the same criteria.

Embodiments of the present invention therefore provide a framework for managing a contact or buddy list of one or more clients 76. To further illustrate advantages of embodiments of the present invention, consider a player (i.e., client user) desiring to operate a mobile station 10 to play an electronic game operated and maintained by a game server 22. In such an instance, the player activates a game client 78 operated by the mobile station to begin a gaming session. After logging on to the game server to begin a gaming session, the game client presents a gaming graphical user interface (GUI) within which the player plays the electronic game, such as by manipulating a character of the player within the electronic game. Also after logging on to the game server, communication functionality (i.e., communication application 88) within the game client is activated to present, in a window of the gaming GUI, the player's buddy list. For example, the player's buddy list may be presented in response to the player actuating a button of a user input interface of the mobile station, or in response to the player actuating a selectable element (selectable tab) presented in the gaming GUI.

The members of the player's buddy list may include members comprising other players of the electronic game that the player has added to an originally empty buddy list. Thus, to add a member to the buddy list, the player may search the database 82 maintained by the client manager 84 for a specific player, such as by manually entering the username of the other player into the game client, or more particularly the window of the gaming GUI for presenting the buddy list, for example. Alternatively, for various electronic games, the player can select another player to add to the player's buddy list by selecting the other player's character from within the gaming GUI, such as by selecting another player's character passing by a current view of the player within the game environment presented by the gaming GUI. Over time, the player can store a number of other players as members within the player's buddy list. Thus, if so desired, the player can coordinate play of the electronic game with members of the player's buddy list simply by selecting the members with whom the player desires to coordinate game play, and exchanging messages with the selected members. Other uses of the buddy list are possible, but coordinating gameplay is one typical advantage to using such a buddy list.

Unfortunately, one of the drawbacks of conventional buddy lists is that such lists can become too large to be easily managed. In accordance with embodiments of the present invention, then, the player of the electronic game can select criteria of those buddy list members with whom the player desires to communicate at a given instance. For example, the player may select criteria of buddy list members that perform the best at certain aspects of the electronic game, buddy list members that perform the best overall, or buddy list members that perform the worst in some aspects. In such instances, the buddy list members who perform at a given level may be determinable based upon criteria such as one or more scores associated with the respective members, such that the buddy list members that perform the worst, for example, are associated with the lowest aggregate scores. In this regard, if the player desires to improve a specific skill set of his game play, the player can select criteria of buddy list members who are good at that skill to facilitate coordinating game play with those members. On the other hand, if the player desires to demonstrate the player's prowess at playing an electronic game, the player may select criteria of buddy list members with very bad players to facilitate coordinating game play with those members. Of course, the player may additionally or alternatively select other criteria, including the duration of gaming sessions. Although the aforementioned criteria involve aspects of game play, the criteria should not be construed as limited to those involving actual game play. The player's selected criteria, could relate, for example, to something as inconsequential as the length of time the buddy list members have been capable of interacting with the game server, such as to play the electronic game.

The contact list manager 86 of embodiments of the present invention is therefore capable of dynamically creating criteria-screened buddy lists based upon the player's buddy list and criteria selected by the player. The contact list manager can then provide the criteria-screened buddy list to the player such that the player can select members of the criteria-screened buddy list with whom to initiate communication, such as to coordinate game play. The contact list manager of embodiments of the present invention therefore permit the player to filter, from the player's contact list, those members not meeting the criteria selected by the player. Thus, the player may be presented with a criteria-screened buddy list including a subset of the members of the player's buddy list.

Embodiments of the present invention have been shown and described with respect to play of an electronic game. It should be understood, however, that embodiments of the present invention are equally applicable outside the context of electronic gaming. In general, then, the contact list manager can be adapted to dynamically create criteria-screened buddy lists in any of a number of different communication contexts, even in the context of a stand-alone IM application. Further, the contact list manager may be adapted to dynamically create other criteria-screened lists outside of IM contexts. For example, in the context of songs in a music play list, the contact list manager may be adapted to dynamically create a music play list based upon a client's music play list and criteria associated with a number of songs included in the play list. In such instances, the criteria associated with the members of the buddy list can comprise any of a number of different criteria associated with interaction of the members with a network entity.

According to one aspect of the present invention, all or a portion of the system of the present invention, such all or portions of the game server 22, routing server 24 and/or client 76 (e.g., mobile station 10, PC system 26, game console 28, etc.), generally operate under control of a computer program product (e.g., game client 78, game application 80, client manager 84, contact list manager 86, communication application 88, etc.). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 6 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of managing a contact list, the method comprising:
providing a contact list identifying a plurality of members, each identified member being associated with at least one criterion; and
dynamically creating at least one criteria-screened list based upon at least one of the criteria associated with the members listed in the contact list, wherein the criteria-screened list is dynamically created based upon at least one of the criteria that is independent of a current presence of the member with respect to the network entity, and wherein the criteria-screened list identifies a subset of the listed members.

2. The method of claim 1, wherein providing a contact list further comprises updating the criteria associated with the members listed in the contact list, and
wherein dynamically creating at least one criteria-screened list comprises dynamically creating at least one criteria-screened list before and after updating the criteria.

3. The method of claim 1, wherein dynamically creating a criteria-screened list comprises:
receiving criteria from a client, the criteria including at least one criterion and at least one threshold value associated with the at least one criterion; and
assembling a criteria-screened list based upon the received criteria.

4. The method of claim 3 further comprising transferring the criteria-screened list to the client such that the client is capable of presenting the criteria-screened list.

5. The method of claim 1, wherein providing a contact list comprises providing a contact list identifying a plurality of members that are each associated with criteria related to at least one of the respective member, and interaction of the respective member with a network entity.

6. The method of claim 5, wherein providing a contact list comprises providing a contact list identifying members associated with at least one criterion related to at least one session of the member, the session being related to interaction of the member with a game application operated by the network entity.

7. The method of claim 6, wherein providing a contact list comprises providing a contact list identifying members associated with at least one criterion related to at least one of a duration of at least one session, a score associated with at least one session, and an aggregate score associated with a plurality of sessions.

8. A system for managing a contact list, the system comprising:
a network entity capable of providing a contact list identifying a plurality of members, each identified member being associated with at least one criterion,
wherein the network entity is also capable of dynamically creating at least one criteria-screened list based upon at least one of the criteria associated with the members listed in the contact list, wherein the network entity is capable of dynamically creating the criteria-screened list based upon at least one of the criteria that is independent of a current presence of the member with respect to the network entity, and wherein the criteria-screened list identifies a subset of the listed members.

9. The system of claim 8 further comprising:
a client capable of sending criteria to the network entity, the criteria including at least one criterion and at least one threshold value associated with the at least one criterion,
wherein the network entity is capable of assembling a criteria-screened list based upon the criteria sent by the client to thereby dynamically create the criteria-screened list.

10. A network entity for managing a contact list, the network entity comprising:
a memory capable of storing a database including a plurality of clients comprising members of a contact list, each identified member being associated with at least one criterion; and
a processor capable of operating a contact list manager, wherein the contact list manager is capable of dynamically creating at least one criteria-screened list based upon at least one of the criteria associated with the members listed in the contact list, wherein the contact list manager is capable of dynamically creating the criteria-screened list based upon at least one of the criteria that is independent of a current presence of the member with respect to the network entity, and wherein the criteria-screened list identifies a subset of the listed members.

11. The network entity of claim 11, wherein the contact list manager is capable of updating the criteria associated with the members listed in the contact list, and wherein the contact list manager is capable of dynamically creating at least one criteria-screened list before and after updating the criteria.

12. The network entity of claim 11, wherein the contact list manager is capable of receiving a request including at least one criterion and at least one threshold value associated with the at least one criterion, and assembling a criteria-screened list based upon the request to thereby dynamically create a criteria-screened list.

13. The network entity of claim 13, wherein the contact list manager is further capable of transferring the criteria-screened list such that the criteria-screened list is capable of being presented for display.

14. The network entity of claim 11, wherein the memory is capable of storing a database including a plurality of clients comprising members of a contact list that are each associated with criteria related to at least one of the respective member, and interaction of the respective member with a network entity.

15. The network entity of claim 15, wherein the memory is capable of storing a database including a plurality of clients comprising members of a contact list that are associated with at least one criterion related to at least one session of the member, the session being related to interaction of the member with a game application operated by the network entity.

16. The network entity of claim 16, wherein the memory is capable of storing a database including a contact list identifying a plurality of clients that are associated with at least one criterion related to at least one of a duration of at least session, a score associated with at least one session and an aggregate score associated with a plurality of sessions.

17. A client for managing a contact list, the client comprising:
a processor capable of operating an application, wherein the application is capable of receiving at least one criterion and at least one threshold value associated with the criteria,
wherein the application is capable of sending a request including the received criteria such that at least one criteria-screened list is capable of being dynamically created based upon the request and a contact list identifying a plurality of members, each identified member in the contact list being associated with at least one criterion, wherein the application is capable of sending the request such that the criteria-screened list is capable of being dynamically created based upon at least one of the criteria that is independent of a current presence of the member with respect to a network entity, and such that the criteria-screened list identifies a subset of the listed members, and
wherein the application is further capable of receiving the dynamically created criteria-screened list.

18. The client of claim 18, wherein the criteria associated with the members listed in the contact list is capable of being updated, and
wherein the application is capable of sending a request in at least one instance such that at least one criteria-screened list is capable of being dynamically created before and after updating the criteria.

19. The client of claim 18, wherein the application is capable of sending the request such that a criteria-screened list is capable of being assembled based upon the criteria included in the request to thereby dynamically create a criteria-screened list.

20. The client of claim 18, wherein the application is further capable of presenting the criteria-screened list to a user.

21. The client of claim 18, wherein the application is capable of receiving at least one criterion related to at least one of the respective member, and interaction of the respective member with a network entity.

22. The client of claim 22, wherein the application is capable of receiving at least one criterion related to at least one session of the member, the session being related to interaction of the member with a game application operated by the network entity.

23. The client of claim 237, wherein the application is capable of receiving at least one criterion related to at least one of a duration of at least one session, a score associated with at least one session and an aggregate score associated with a plurality of sessions.

24. A computer program product for managing a contact list, wherein the computer program product comprises at least one computer-readable storage medium having computer-readable program code portions stored therein, the computer-readable program code portions comprising:
first executable portion for providing a contact list identifying a plurality of members, each identified member being associated with at least one criterion related to interaction of the member with a network entity; and
a second executable portion for dynamically creating at least one criteria-screened list based upon at least one of the criteria associated with the members listed in the contact list, wherein the second executable portion is adapted to dynamically create the criteria-screened list based upon at least one of the criteria that is independent of a current presence of the member with respect to the network entity, and wherein the criteria-screened list identifies a subset of the listed members.

25. The computer program product of claim 25, wherein the first executable portion is further adapted to update the criteria associated with the members listed in the contact list, and
wherein the second executable portion is adapted to dynamically create at least one criteria-screened list before and after updating the criteria.

26. The computer program product of claim 25, wherein the second executable portion is adapted receive, from a client, criteria including at least one criterion and at least one threshold value associated with the at least one criterion, and assemble the criteria-screened list based upon the received criteria to thereby dynamically create the criteria-screened list.

27. The computer program product of claim 27 further comprising a third executable portion for transferring the criteria-screened list to the client such that the client is capable of presenting the criteria-screened list.

28. The computer program product of claim 25, wherein the first executable portion is adapted to provide a contact list identifying a plurality of members that are each associated with criteria related to at least one of the respective member, and interaction of the respective member with a network entity.

29. The computer program product of claim 29, wherein the first executable portion is adapted to provide a contact list identifying members associated with at least one criterion related to at least one session of the member, the session being related to interaction of the member with a game application operated by the network entity.

30. The computer program product of claim 30, wherein the first executable portion is adapted to provide a contact list identifying members associated with at least one criterion related to at least one of a duration of at least session, a score associated with at least one session and an aggregate score associated with a plurality of sessions.
